(19) United States
(12) Patent Application Publication
(10) Pub. No.: US 2025/0224260 A1
(43) Pub. Date: Jul. 10, 2025

(54) ADAPTIVE SENSOR MOUNT ASSEMBLY

(71) Applicant: FLEXICON CORPORATION, Bethlehem, PA (US)

(72) Inventors: David R. GILL, Easton, PA (US); David MCCLANAHAN, Harleysville, PA (US); Daniel Joel BARRY, Nazareth, PA (US)

(73) Assignee: FLEXICON CORPORATION, Bethlehem, PA (US)

(21) Appl. No.: 18/859,820

(22) PCT Filed: Sep. 29, 2022
(86) PCT No.: PCT/US2022/045133

§ 371 Date: Oct. 24, 2024

Related U.S. Application Data
(60) Provisional application No. 63/249,937, filed on Sep. 29, 2021.
(60) Provisional application No. 63/311,298, filed on Feb. 17, 2022.

(51) Int. Cl. G01D 11/30

(52) U.S. Cl. CPC G01D 11/30

(57) ABSTRACT

An adaptive sensor mount assembly for mounting a sensor to a vessel is disclosed herein. The assembly includes a mount body configured to be attached to the vessel. A flange is connected to the mount body, and the flange is configured to be arranged within an interior area of the vessel. A sensor assembly is configured to be retained with the mount body. A mounting element is configured to engage with the mount body in an exterior area relative to the vessel. Engagement of the mounting element with the mount body is configured to draw the flange against an interior surface of the vessel to provide a seal either directly via the flange abutting the vessel wall or via the flange compressing a gasket arranged between the flange and the vessel wall.

### CROSS REFERENCE TO RELATED APPLICATIONS

This application is the United States National Stage Application of International Patent Application No. PCT/US2022/045133 filed on Sep. 29, 2022, which claims priority to U.S. Provisional Patent Application 63/249,937, filed on Sep. 29, 2021, and U.S. Provisional Patent Application 63/311,298, filed on Feb. 17, 2022, all of which are incorporated herein by reference.

### FIELD OF THE INVENTION

The present disclosure relates to a sensor mount assembly.

### BACKGROUND

Bulk materials can be transported and/or stored in a variety of ways. In one type of arrangement, vessels, such as hoppers or other processing conduits, are provided that generally move materials from one location or container to another. These vessels can be provided in variety of shapes, sizes, and profiles, and may include flat, cylindrical, curved, or domed surfaces. The vessels can be made from a variety of materials, such as steel, aluminum, or plastic. It is important for processing that the materials within these vessels can be detected or sensed.

One known type of detection arrangement includes electrically operated switches that are mounted in an opening of the walls of hoppers, vessels, or processing equipment. The sensors can detect bulk material through a change in an emitted field or obstruction of the line of sight of the sensor. Once detected, a signal is sent from the sensor to a controller, indicating the presence of material in the vicinity of the sensor.

It is generally known to use barrel shaped sensor assemblies for these applications. A sensor is typically mounted in an opening of the wall of the vessel using an internally threaded coupling, tapped hole, or a plain through hole. In these arrangements, the sensor is positioned against the hopper or vessel wall using a lock nut or washer. In order to prevent leaks, sealing tape, such as polytetrafluoroethylene (PTFE) tape, or another type of seal is often required.

There is a problem with existing seal arrangements in terms of providing reliable seals and also damage to the mounted sensors. Additionally, existing mounting bodies can have a relatively large profile that may obstruct the flow of bulk materials in the vessel.

Therefore, a need exists for an improved sealing arrangement and mounting body configuration.

### SUMMARY

An adaptive sensor mount assembly for mounting a sensor to a vessel is disclosed herein. The assembly includes a mount body configured to be attached to the vessel. A flange is connected to the mount body, and the flange is configured to be arranged within an interior area of the vessel. The flange can have some degree of flexibility in order to conform to a profile defined by a wall of the vessel. A sensor assembly is configured to be retained with the mount body. A mounting element is configured to engage with the mount body in an exterior area relative to the vessel. Engagement of the mounting element with the mount body is configured to draw the flange against an interior surface of the vessel to provide a seal, either directly or indirectly via engagement with a gasket.

The mount body can include an interior cavity and the sensor assembly can be configured to be retained within the interior cavity.

The interior surface of the vessel can be curved or domed, in one aspect.

The mount body can include internal threading and external threading. The mounting element is a nut, in one aspect, that includes internal threading configured to engage with the external threading of the mount body. The sensor assembly can include external threading configured to engage with the internal threading of the mount body.

A gasket can be arranged on an underside of the flange. The gasket is configured to provide a seal between the interior surface of the vessel and the underside of the flange. In one aspect, the flange is made of a material so as to not require a separate gasket. The flange can be configured to compress or engage with the gasket such that the gasket is secured against the interior surface of the vessel.

The sensor assembly can be a capacitance sensor element. The sensor assembly can alternatively be an optical sensor element. In another aspect, the sensor assembly is a magnetic sensor element.

A sensor nut can be configured to engage with an external threading of the sensor assembly, and the sensor nut is configured to axially abut an end of the mount body.

The mount body can be formed via injection molding, and the flange can be formed integrally with the mount body.

The sensor assembly can be positioned entirely outside of the interior area of the vessel in a mounted state.

The mount body can include a protrusion that is configured to project inwardly with respect to the interior area of the vessel, in one example.

In another aspect, a method for securing an adaptive sensor mount assembly relative to a vessel is provided.

Additional embodiments are described herein.

### BRIEF DESCRIPTION OF THE DRAWINGS

The foregoing Summary as well as the following Detailed Description will be readily understood in conjunction with the appended drawings which illustrate preferred embodiments of the invention. In the drawings:

FIG. 1A is a cross-sectional view of an adaptive sensor mount assembly including a gasket according to one aspect in a mounted or installed state.

FIG. 1B is top view of the adaptive sensor mount assembly of FIG. 1A in a non-mounted state.

FIG. 1C is a cross-sectional view of the adaptive sensor mount assembly along line 1C-1C of FIG. 1B.

FIG. 1D is another cross-sectional view of the adaptive sensor mount assembly of FIG. 1A.

FIG. 2 is a cross-sectional view of an adaptive sensor mount assembly according to another aspect.

FIG. 3A is a top view of an adaptive sensor mount assembly according to another aspect.

FIG. 3B is a cross-sectional view of the adaptive sensor mount assembly along line 3B-3B of FIG. 3A.

FIG. 3C is a top view of the adaptive sensor mount assembly of FIGS. 3A and 3B in an installed state.

FIG. 4 is a top view of an adaptive sensor mount assembly according to another aspect.

FIG. 5A is a cross-sectional view of an adaptive sensor mount assembly according to another aspect.

FIG. 5B is a bottom view of the adaptive sensor mount assembly of FIG. 5A.

FIG. 6 is a cross-sectional view of an adaptive sensor mount assembly according to another aspect.

FIG. 7A is a side view of an adaptive sensor mount assembly according to another aspect with a separately formed mount body and flange.

FIG. 7B is a cross-sectional view along line 7B-7B of FIG. 7A.

FIG. 7C is a side view of the adaptive sensor mount assembly of FIGS. 7A and 7B with the flange and the mount body in a detached state.

FIG. 8A is a cross-sectional view of another mount body for a sensor mount assembly along line 8A-8A from FIG. 8E.

FIG. 8B is a first side view of the mount body of FIG. 8A.

FIG. 8C is a perspective view of the mount body of FIGS. 8A and 8B.

FIG. 8D is another side view of the mount body of FIGS. 8A-8C.

FIG. 8E is an axial view of the mount body of FIGS. 8A-8D.

FIG. 8F is another side of the mount body of FIGS. 8A-8E.

FIG. 8G is a cross-sectional view of the adaptive sensor mount assembly of FIGS. 8A-8F including a gasket according to one aspect in a mounted or semi-installed state.

FIG. 8H is a cross-sectional view of the adaptive sensor mount assembly of FIGS. 8A-8G including a gasket according to one aspect in a mounted or fully installed state.

FIG. 9A is a cross-sectional view of another mount body for a sensor mount assembly along line 9A-9A from FIG. 9E.

FIG. 9B is a first side view of the mount body of FIG. 9A.

FIG. 9C is a perspective view of the mount body of FIGS. 9A and 9B.

FIG. 9D is another side view of the mount body of FIGS. 9A-9C.

FIG. 9E is an axial view of the mount body of FIGS. 9A-9D.

FIG. 9F is another side of the mount body of FIGS. 9A-9E.

FIG. 9G is a cross-sectional view of the adaptive sensor mount assembly of FIGS. 9A-9F including a gasket according to one aspect in a mounted or semi-installed state.

FIG. 9H is a cross-sectional view of the adaptive sensor mount assembly of FIGS. 9A-9G including a gasket according to one aspect in a mounted or fully installed state.

### DETAILED DESCRIPTION

Certain terminology is used in the following description for convenience only and is not considered limiting. The words “right,” “left,” “lower” and “upper” designate directions in the drawings to which reference is made. This terminology includes the words specifically noted above, derivatives thereof and words of similar import. Additionally, the terms “a” and “one” are defined as including one or more of the referenced items unless specifically noted.

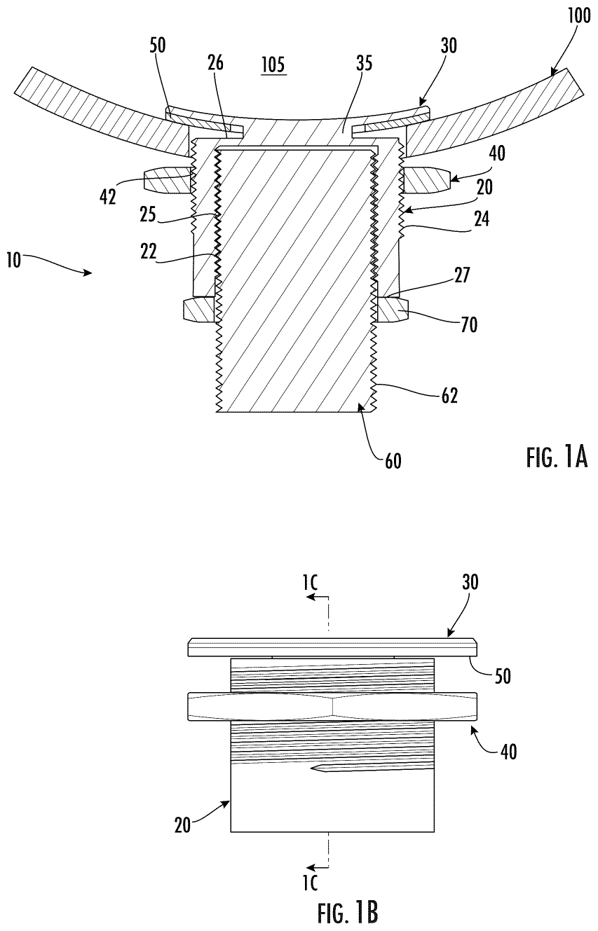

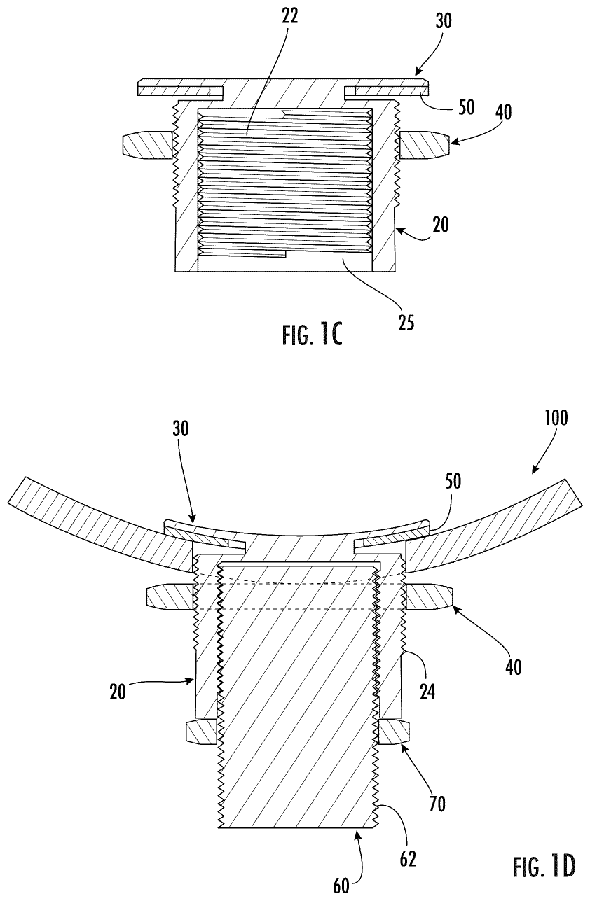

An adaptive sensor mount assembly 10 configured to be mounted to a vessel 100 is generally disclosed herein and shown in FIGS. 1A-1D. The adaptive sensor mount assembly 10 generally includes a mount body 20. The mount body 20 is configured to attach to a wall or other surface of a vessel 100.

The mount body 20 defines an interior cavity 25, in one aspect. The interior cavity 25 is generally configured to receive and retain a sensor element. One of ordinary skill in the art would understand that the mount body 20 could include different shapes or profiles that do not include a cavity, and instead includes other receptacles or retainers to secure the mount body 20 with a sensor. The mount body 20 can have a generally cup-shaped profile and include internal threading 22 and external threading 24, in one aspect. One of ordinary skill in the art would understand that other types of connection elements or mating elements can be formed on any part of the mount body 20.

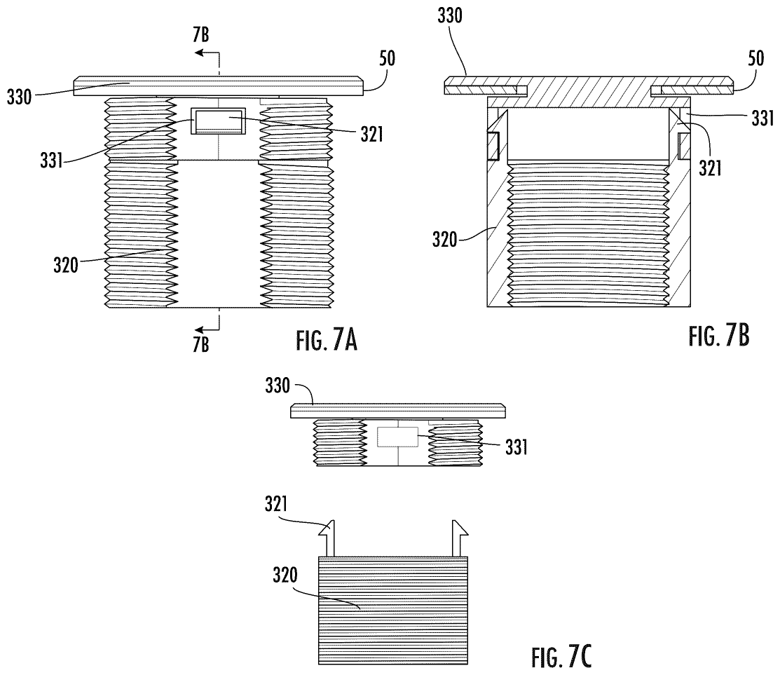

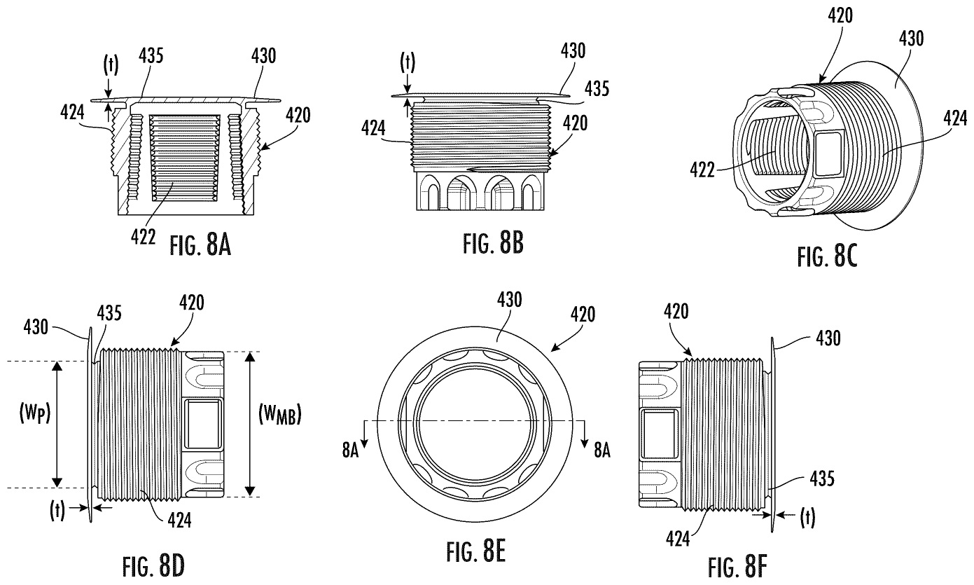

In order to secure the mount body 20 to the vessel 100, a flange 30 is provided. The flange 30 is connected to the mount body 20. As used in this respect, the term connected can mean a direct or indirect connection. In a specific aspect, the flange 30 is directly connected to the mount body 20 via a post 35. In one aspect, the post 35 can be formed as a hinge pin. The post 35 is generally arranged in a medial region of an axial end 26 of the mount body 20. Based on this configuration, the lateral edge or radial edge of the flange 30 is cantilevered or unsupported, and therefore capable of flexing or bending. In one aspect, a width of the post 35 is 25%-75% of a width of the mount body 20. In another aspect, as shown by the mount body 420 of FIGS. 8A-8H, a width (Wp) of the post 435 can be at least 75% of the entire width (Wmb) of the mount body 420. For example, the width (Wp) of post 435 can be at least approximately 80% of the entire width (Wmb) of the mount body 420, in one aspect. The width (Wp) of the post 435 can be 80-90% of the entire width (Wmb) of the mount body 420, in another aspect. In one aspect, the width (Wmb) of the mount body 420 does not include the outer surface of the external threading 424. As shown in FIG. 8A, an interior surface of the post 435 is continuous with the interior surface of the mount body 420 that defines the internal threading 422. Other aspects of the mount body 420, such as the external threading 424 are otherwise similar to the other embodiments illustrated in this disclosure. FIG. 8G illustrates the mount body 420 in a semi-installed position but prior to the gasket 450 being in contact with the interior surface of the vessel 100. FIG. 8H shows the mount body 420 in a more fully mounted position such that the gasket 450 conforms to the profile of the interior surface of the vessel 100. The gasket 450 can be configured to compress or be squeezed between the flange 430 and the interior of the vessel wall, such that a reliable seal is provided. The flange 430 has some flexibility such that the flange 430 also is configured to conform or bend to match a profile of the vessel wall. The gasket 450 can be omitted, in one example.

One of ordinary skill in the art would understand that the width of the post 35, as well as the thickness of the flange 30 can vary. The flange 30 is configured to be arranged within an interior area 105 of the vessel 100. The flange 30 has a radial dimension that is larger than an outermost radial dimension of the mount body 20.

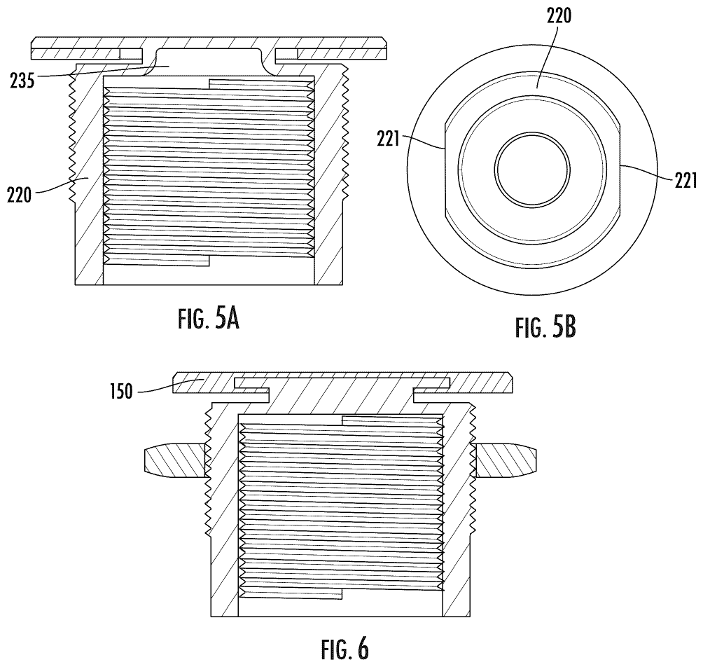

As shown in FIG. 5A, in one aspect, the post 235 has a hollow interior. The assembly shown in FIG. 5A is otherwise similar to the assembly shown in FIGS. 1A-1D. As shown in FIG. 5B, the adaptive sensor mount assembly can include flats 221 on diametrically opposed regions of the mount body 220.

In another aspect, the mount body and the flange can be formed separately from each other. In this configuration, the post can be formed with a first one of the mount body or the flange, and the post can be configured to be attached to a second one of the mount body or the flange.

FIGS. 7A-7C illustrate an embodiment in which the mount body 320 is formed separately from the flange 330. In this arrangement, the flange 330 can include a post or stud that is configured to mate with the mount body 320. The post or stud on the flange 330 can include external threading, similar to the external threading on the mount body 320, which is also configured to engage or mate with the mounting nut 40. As shown in FIGS. 7A-7C, the mount body 320 can include prongs 321 that are configured to engage with pockets or receptacles 331 formed on the flange 330. In one aspect, there are two prongs 321 and two receptacles 331. One of ordinary skill in the art would understand the quantity of prongs or receptacles can vary. In another aspect, the flange 330 can include prongs and the mount body 320 can include receptacles. In one aspect, this configuration provides a snap-on attachment arrangement. Other attachment configurations, such as connections using a threading, could be used.

One of ordinary skill in the art would understand from this disclosure that various arrangements for attaching the flange 30 to the mount body 20 can be used. In one aspect, a multi-part adaptive sensor mount assembly provides the ability to provide interchangeable threaded mount bodies for various sensor form factors. In another aspect, this configuration also allows for insertion of the adaptive sensor mount assembly from the inside or outside of the vessel 100.

In one aspect, the mount body 20 is formed via injection molding. The flange 30 and the post 35 can be formed integrally with the mount body 20. One of ordinary skill in the art would understand that various other types of formation processes and configurations could be used to form the mount body 20. In one aspect, an average thickness of the flange 30 is 1.0 mm-3.0 mm. One of ordinary skill in the art would understand that this thickness can vary. For example, as shown in FIGS. 8A-8H, a thickness (t) of the flange 430 can be approximately 1.0 mm, in one aspect. The thickness of the flange can be approximately 0.5 mm, in one aspect.

A sensor assembly 60 is configured to be attached or retained relative to the mount body 20. In one aspect, the sensor assembly 60 is configured to be at least partially retained within the interior cavity 25 of the mount body 20. The sensor assembly 60 can be arranged to abut against the axial end 26 of the mount body 20.

The sensor assembly 60 can include an external threading 62 configured to engage with the internal threading 22 of the mount body 20. During installation, personnel can manually rotate the sensor assembly 60 and the mount body 20 relative to each other to provide a secure fastening arrangement between these components. One of ordinary skill in the art would understand that other types of fastening arrangements could be used to secure the sensor assembly 60 with the mount body 20. In one example, the entire body of the sensor assembly 60 is a sensor. The sensor assembly 60 can include various electronic components inside of the body of the sensor assembly 60, in one example. Any sensor assembly or sensor body can be used that is configured to engage inside the mount body and remain secured within the mount body.

A mounting element 40, such as a mounting nut 40, is provided that is configured to engage with the mount body 20 in an exterior area relative to the vessel 100. The mounting nut 40 can include an internal threading 42 configured to engage with the external threading 24 of the mount body 20. One of ordinary skill in the art would understand that other types of fastening arrangements could be used. For example, a clamping ring could be provided to secure the mount body 20 relative to the vessel 100. Contact between the mounting nut 40 and the outer surface of the vessel 100 is shown in FIG. 1D.

Engagement of the mounting nut 40 with the mount body 20 is configured to draw the flange 30 axially outward relative to the interior area 105 of the vessel and against an interior surface of the vessel 100. In one aspect, the flange 30 can be engaged directly against the interior surface of the vessel 100. In another aspect, an intermediate component, such as a gasket, seal, or a rubber layer or component, can be arranged between the flange 30 and the interior surface of the vessel 100. Regardless of the type of engagement, tightening of the mounting nut 40 relative to the mount body 20 causes the flange 30 to deform against the interior of the vessel 100 such that the flange 30 conforms to the profile of the interior of the vessel 100.

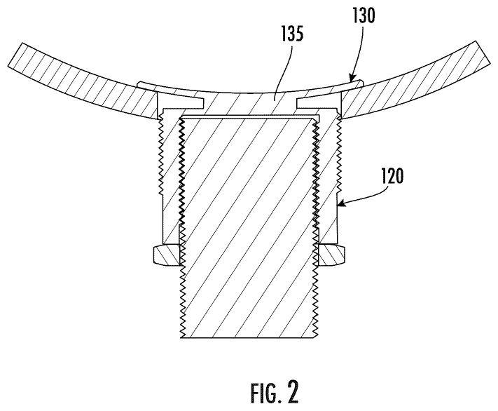

In one embodiment, a gasket 50 is provided. The gasket 50 can be an optional component, as shown in FIG. 2 which omits the gasket. The mount body 120 shown in FIG. 2 is generally identical to the mount body 20 of FIGS. 1A-1D except the flange 130 itself provides a seal against the vessel 100 instead of a separately formed gasket. The mount body 120 similarly includes a post 135 that provides a connection to the flange 130.

In one aspect, the gasket 50 is arranged in contact with the flange 30 and against an interior surface of the vessel 100, as shown in FIG. 1A. In one aspect, the gasket 50 is positioned on an underside of the flange 30 and is configured to provide a seal between an interior surface of the vessel 100 and the underside of the flange 30. The gasket 50 can be separately formed from the flange 30. As used in this context, the term underside refers to a surface of the flange 30 directly facing the interior wall of the vessel 100. In one aspect, the gasket 50 has an outer radial dimension that is approximately the same as an outer radial dimension of the flange 30. An outer radial dimension of the gasket 50 is preferably at least 125% of an outer radial dimension of the opening or hole in the vessel 100 in order to provide a reliable seal. One of ordinary skill in the art would understand that this value can vary. In one aspect, a thickness of the gasket 50 is greater than a thickness of the flange 30. One of ordinary skill in the art would understand that these thicknesses can vary. As shown in FIG. 6, a gasket 150 can be overmolded around the flange. All other aspects of the mount body assembly of FIG. 6 are identical to those shown and described in FIGS. 1A-1D. Other attachment configurations could be used to join the gasket to the flange.

In one aspect, the sensor assembly 60 is a capacitance sensor element. In another aspect, the sensor assembly 60 is an optical sensor configured to detect materials within the vessel 100. In this type of arrangement, the mount body 20 could be formed from a clear or transparent material. In another aspect, the sensor assembly 60 is a magnetic sensor that is configured to detect magnetic or ferrous materials within the vessel 100. One of ordinary skill in the art would recognize based on the present disclosure that various types of sensors could be used. The sensor assembly 60 is generally configured to send a signal to a controller that indicates the presence of materials being conveyed or stored within the vessel 100.

A sensor securing element 70, such as a sensor nut 70, can be provided for generally securing and locking the sensor assembly 60 relative to the mount body 20. In one aspect, the sensor nut 70 is configured to engage with an external threading 62 of the sensor assembly 60 and axially abut an axial end 27 of the mount body 20. One of ordinary skill in the art would understand that other types of securing elements besides nuts could be used, such as clamping rings.

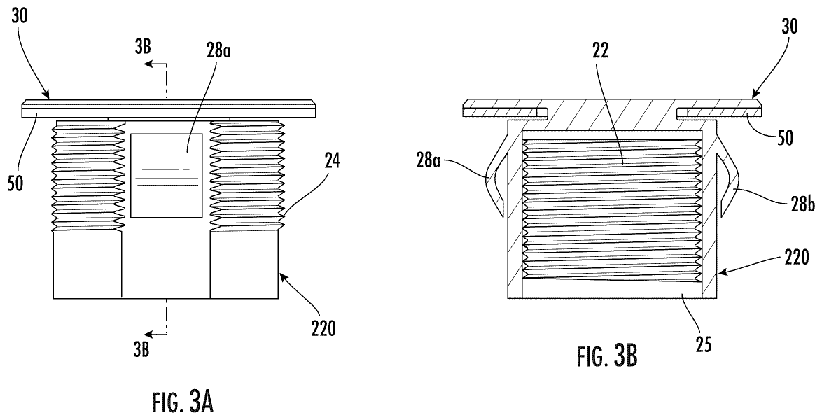

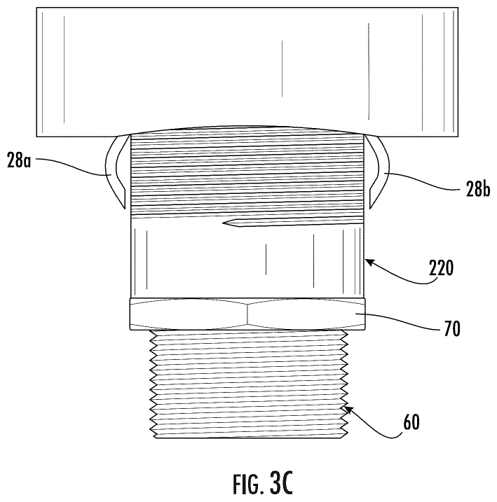

In one aspect, a secondary mounting feature can also be provided on the mount body 20. As shown in FIGS. 3A-3C, the mount body 220 can include flexible fingers 28a, 28b that are configured to project radially outward from the mount body 220. The fingers 28a, 28b can be configured to provide assistance during installation by temporarily securing the mount body 220 within the opening defined by the vessel 100. During this temporary step, personnel do not need to hold the mount body 220 in position because the fingers 28a, 28b retain the mount body 220 relative to the vessel 100. Accordingly, personnel can attend to other components of the assembly 10, thus making installation easier. The external threading 24 on the mount body 220 can be defined on portions of the mount body 220 away from the fingers 28a, 28b, in one aspect, as shown in FIG. 3A. One of ordinary skill in the art would understand that the fingers 28a, 28b can be omitted.

In one aspect, the sensor assembly 60 is positioned entirely outside of the interior area 105 of the vessel 100. As shown in FIG. 1A, the sensor assembly 60 can be partially arranged in the opening defined by the vessel 100.

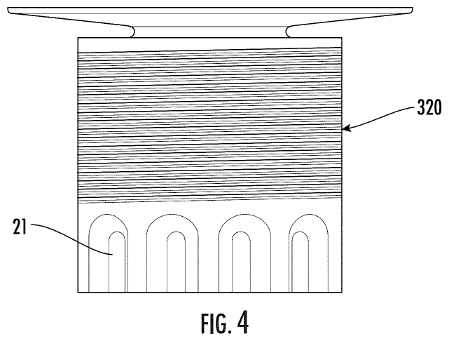

As shown in FIG. 4, in one aspect the mount body 320 can include a gripping feature 21. As shown in FIG. 4, the gripping feature 21 can include a plurality of axially extending grooves on a radially outer surface of the mount body 320 and on an opposite axial end of the mount body 320 from the flange. One of ordinary skill in the art would understand that other types of gripping features could be used, such as ribs, protrusions, textured or patterned surfaces, etc.

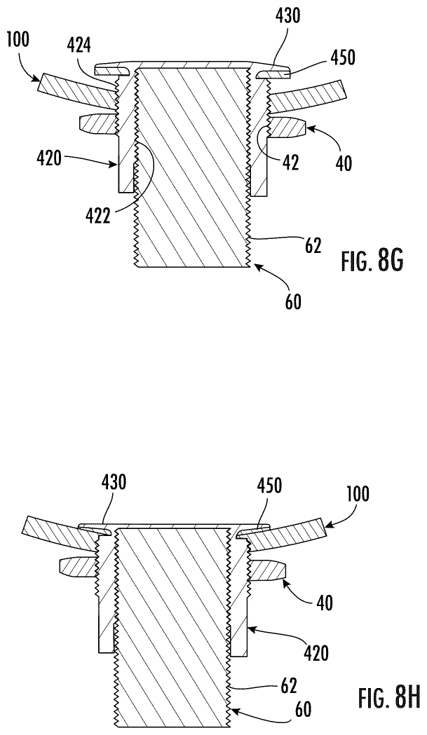

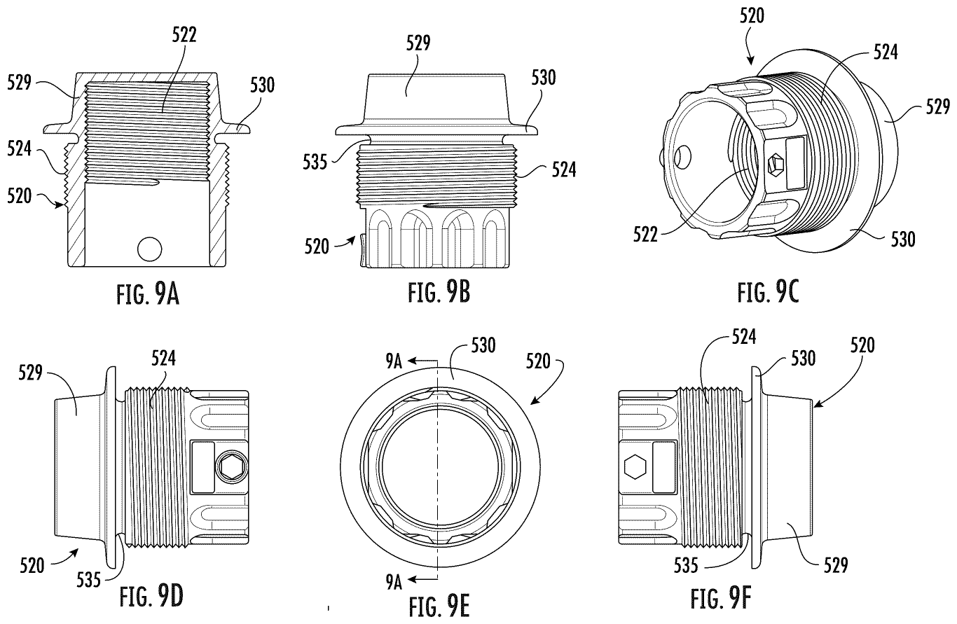

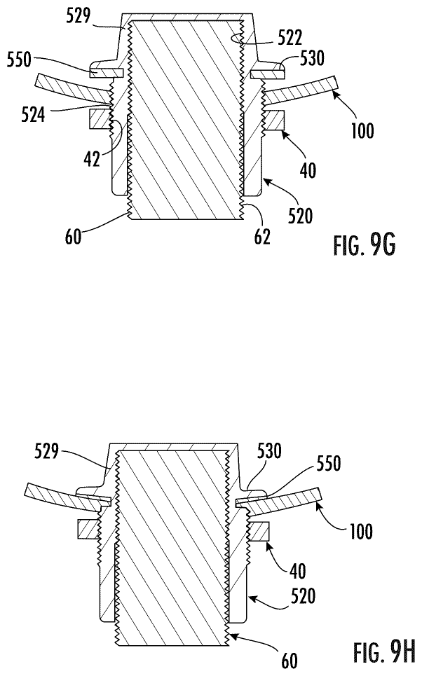

As shown in FIGS. 9A-9H, another mount body 520 is provided. The mount body 520 includes an internal threading 522, external threading 524, a flange 530 and a post 535. The mount body 520 of FIGS. 9A-9H is relatively similar to the other mount bodies disclosed herein, except the mount body 520 includes a protrusion 529 that is configured to extend inside of the interior area 105 of the vessel 100. The configuration of FIGS. 9A-9H provides an arrangement in which the sensor 60 can penetrate more deeply into the vessel 100 as compared to other embodiments of the mount body. This is advantageous for various reasons, such as providing some separation between the wall of the vessel 100 and a tip of the sensor 60 due to some vessel walls being made from metal or other materials that may interfere with the sensor 60 functioning properly. FIG. 9G illustrates the mount body 520 in a semi-installed position but prior to the gasket 550 being drawn into contact with the interior surface of the vessel 100. FIG. 9H shows the mount body 520 in a more fully mounted position such that the gasket 550 conforms to the profile of the interior surface of the vessel 100. The gasket 550 can be configured to compress or be squeezed between the flange 530 and the interior of the vessel wall, such that a reliable seal is provided. The gasket 550 can be omitted, in one example.

In each of the embodiments disclosed herein, the flange on the mount body can generally be configured to either engage directly with an interior surface of the vessel wall or be configured to compress a gasket arranged on an underside of the flange such that the gasket and the flange both conform and press against an interior surface of the vessel wall. In each configuration, the mount body provides a seal between an interior and exterior of the vessel, while also providing a convenient mounting configuration for a sensor assembly or sensor body therein.

A method of securing an adaptive sensor mount assembly 10 to a vessel 100 is also disclosed herein. The method can include forming an opening or hole in a wall of the vessel 100. The opening or hole in the vessel 100 can be formed as a plain circular opening without any threading or grooves.

In one aspect, the opening or hole in the vessel 100 can be formed with a geometry that matches an outer profile of the mount body 20. For example, in one embodiment, the mount body 20 can include two diametrically opposed flat sections and the opening in the vessel 100 can similarly include flat sections. One of ordinary skill in the art would understand that various profiles can be selected for the opening in the vessel 100 and the mount body 20 itself.

The method can include inserting the mount body 20 from an inside or interior of the vessel 100, and securing the mount body 20 to the vessel 100. In another aspect, the method can include inserting the mount body 20 from an outside of the vessel 100, which would require slight and temporary bending of the flange 30 to fit through the opening in the vessel 100. Alternatively, a multi-part design in which the mount body 20 is formed separately from the flange 30 can also allow for insertion from an exterior of the vessel 100.

In one aspect, the gasket 50 can already be arranged underneath the flange 30 during the insertion step. The mount nut 40 can also be arranged around the mount body 20 during this step.

Once arranged around the mount body 20, the mount nut 40 is rotated such that the mount nut 40 moves axially along the mount body 20 until engaging an exterior surface of the vessel 100. As the mount nut 40 is tightened, the flange 30 is drawn outward and conforms to a profile defined by an interior wall or surface of the vessel 100.

The method can further include installing the sensor assembly 60 relative to the mount body 20, such as by rotating the sensor assembly 60 such that threading on the sensor assembly 60 engages threading on the mount body 20. The method can further include installing a sensor nut 70 with the assembly 10 to secure the sensor assembly 60 relative to the mount body 20.

The present assembly and method provide multiple advantages over known sensor mounting assemblies. By positioning the sensor assembly 60 completely outside of the interior of the vessel 100, the sensor assembly 60 does not experience any damage or contact with the bulk materials being conveyed through the vessel 100. This results in an improved expected life cycle for the sensor assembly 60. Additionally, more sensitive, complex, and/or expensive sensor assemblies 60 can be used.

The assembly 10 disclosed herein also provides an improved and extended sensing range by removing steel from the immediate vicinity of the sensor assembly 60. In one aspect, this advantage is realized due to a reduction in mass and conductivity of adjacent material (i.e. the mount body) when using a capacitive sensor. By providing a plastic mount body in one embodiment, the present disclosure ensures that the capacitive sensor is less influenced by the vessel wall. The plastic mount body further isolates the sensor from its surroundings, which further increases its sensitivity to the materials inside of the vessel.

The present assembly 10 provides a relatively simplified mounting arrangement which makes it easier to retrofit older vessels. The present arrangement eliminates the need for complex mounts or field welding, which makes it easier and more convenient to install the assembly 10 in the field of use.

Due to the arrangement of the flange 30 and the gasket 50, the present assembly 10 also provides an improved configuration for controlling a depth of the assembly 10 relative to the interior of the vessel 100.

The present assembly 10 provides an arrangement in which the threading of the mount body 20, and any other component of the assembly 10, is not exposed to the interior area 105 of the vessel 100. Instead, only the flange 30 and the gasket 50 are arranged inside of the vessel 100. Particularly in food processing applications, threads are disadvantageous and undesirable due to food stuffs becoming entrapped in the root of the thread, which is difficult to remove and clean. A smooth contact face on the flange 30 provides an improved configuration which is easier to keep clean and free of food stuffs.

The present assembly 10 also provides a mount body 20 which is configured to act as a plug for the opening in the vessel 100. Accordingly, the sensor assembly 60 can be removed from the installed mount body 20 and the mount body 20 can remain in the vessel 100. This provides the ability to change or relocate the sensor without emptying the vessel 100. Further, if the mount body 20 is formed from a transparent material, then the mount body 20 can acts as a sight glass when the sensor is removed.

It is also understood that various portions of the invention can be used alone or in combination and that not all of the components are required for any particular application. It is therefore understood that this invention is not limited to the particular embodiments disclosed, but it is intended to cover modifications within the spirit and scope of the present invention.

1. An adaptive sensor mount assembly for mounting a sensor to a vessel, the assembly comprising:
a mount body being configured to be attached to the vessel;
a flange connected to the mount body, the flange configured to be arranged within an interior area of the vessel;
a sensor assembly configured to be retained with the mount body; and
a mounting element configured to engage with the mount body in an exterior area relative to the vessel, wherein engagement of the mounting element with the mount body is configured to draw the flange towards the exterior area of the vessel such that the flange conforms to a profile defined by the vessel.

2. The assembly according to claim 1, wherein the mount body includes an interior cavity and the sensor assembly is configured to be retained within the interior cavity of the mount body.

3. The assembly according to claim 1, wherein the interior surface of the vessel is curved

4. The assembly according to claim 1, wherein an average thickness of the flange is 0.5 mm-3.0 mm.

5. The assembly according to claim 1, wherein the mount body includes a protrusion on an axial end that is configured to project within the interior area of the vessel and partially house the sensor assembly.

6. The assembly according to claim 1, wherein the mount body includes internal threading and external threading.

7. The assembly according to claim 6, wherein the mounting element is a nut that includes internal threading configured to engage with the external threading of the mount body.

8. The assembly according to claim 6, wherein the sensor assembly includes external threading configured to engage with the internal threading of the mount body.

9. The assembly according to claim 1, further comprising a gasket arranged on an underside of the flange, the gasket being configured to provide a seal between the interior surface of the vessel and the underside of the flange.

10. The assembly according to claim 9, wherein the gasket is overmolded with the flange.

11. The assembly according to claim 1, wherein the sensor assembly comprises at least one of a capacitance sensor element, an optical sensor element, or a magnetic sensor element.

12. The assembly according to claim 1, further comprising a sensor nut configured to engage with an external threading of the sensor assembly, the sensor nut being configured to axially abut an end of the mount body.

13. The assembly according to claim 1, wherein the mount body is formed via injection molding, and the flange is formed integrally with the mount body.

14. The assembly according to claim 1, wherein the sensor assembly is positioned entirely outside of the interior area of the vessel.

15. The assembly according to claim 1, wherein the mount body includes at least one flexible finger that is configured to retain the mount body within an opening of the vessel.

16. The assembly according to claim 1, wherein the mount body includes a plurality of axially extending grooves on a radially outer surface of the mount body.

17. The assembly according to claim 1, wherein the mount body and the flange are formed as two separate components, and the mount body and the flange are connected to each other via mating elements.

18. The assembly according to claim 17, wherein the mount body includes at least two prongs, and the flange includes at least two receptacles configured to mate with the at least two prongs.

19. A method for securing an adaptive sensor mount assembly to a vessel, the method comprising:
arranging a portion of a mount body inside of a vessel, the mount body including a flange on an axial end;
securing a mounting element to the mount body in an exterior area relative to the vessel, wherein securing the mounting element with the mount body forces the flange to conform to an interior surface of the vessel and provide a seal; and
securing a sensor assembly to the mount body such that the sensor assembly is configured to detect materials within the vessel.

20. The method according to claim 19, wherein the mount body is formed via injection molding, and the flange is formed integrally with the mount body.

21. The method according to claim 19, wherein the sensor assembly is positioned entirely outside of an interior area of the vessel.

22. The method according to claim 19, further comprising arranging a gasket on an underside of the flange.

23. The assembly according to claim 1, wherein an axial end of the mount body directed toward the vessel covers the sensor assembly.
